(19) United States
(12) Patent Application Publication
(10) Pub. No.: US 2008/0141284 A1
(43) Pub. Date: Jun. 12, 2008

(54) Device Driver Providing Method, Information Device, and Peripheral Device

(75) Inventor: Makoto Tomizu, Kanagawa (JP)

Correspondence Address: PROCOPIO, CORY, HARGREAVES & SAVITCH LLP, 530 B STREET, SUITE 2100, SAN DIEGO, CA, 92101, US

(73) Assignee: KYOCERA CORPORATION, Kyoto (JP)

(21) Appl. No.: 11/568,787

(22) PCT Filed: Apr. 28, 2005
(86) PCT No.: PCT/JP05/08554

§ 371 Date: Jun. 4, 2007

(30) Foreign Application Priority Data
May 7, 2004 (JP) JP-2004-138042

(51) Int. Cl. G06F 9/44

(52) U.S. Cl. 719/321

(57) ABSTRACT

A device driver providing method of providing an information device including an external interface with a device driver for a peripheral device to be connected through the external interface, includes a first step in which, when the peripheral device is connected to the information device through the external interface, the information device transmits information related to an operating system in the information device to the peripheral device, a second step in which the peripheral device determines whether a device driver, which is compatible with the received information related to the operating system, is stored in the peripheral device, and a third step in which, when it is determined that the device driver is stored, the peripheral device transmits the device driver to the information device.

### TECHNICAL FIELD

The present invention relates to a device driver providing method of providing a device driver between an information device and a peripheral device that are connected through an external interface. The present invention also relates to an information device and a peripheral device provided for the device driver providing method.

### BACKGROUND ART

There are information devices, such as personal computers, nowadays that include an internal interface to enable connection with a peripheral device.

Such an information device permits the following usages. By connecting this information device to, for example, a digital camera, transferring of image data stored in the digital camera to the information device, can be performed, or by connecting the information device to a printer, outputting the printer of image data or text data stored in the information device can be performed.

In, for example, JP-A-2003-241867, it is disclosed that an information device, such as a personal computer, and a peripheral device (portable terminal) are connected by a communication cable to perform data transmission.

However, in order to perform data communication between the information device and the peripheral device through a communication cable as described in the above publication, the device driver of the peripheral device must be installed in the information device, and the information device must correctly identify the peripheral device before data transmission is performed in the appropriate procedures.

Conventionally, for installation of the device driver of a peripheral device in an information device, a user must manually install, in the information device, a device driver stored on a medium, such as an FDD (Floppy (R) Disk) or a CD-ROM (Compact Disc-Read Only Memory), that is packaged with the peripheral device.

A compatible operating system is determined for a device driver, and a compatible device driver must be installed in the operating system in the information device.

However, a user could, erroneously, manually install an incorrect device driver that is not compatible with the operating system of the information device, and accordingly, the information device either would not correctly identify the peripheral device, or would perform an erroneous operation.

Further, the user may install an incorrect device driver because the user misunderstands the type of operating system installed in the information device, and accordingly, the information device either would not correctly identify the peripheral device, or would perform an erroneous operation.

Therefore, an object of the present invention is to enable to install, in an information device, a correct device driver for a peripheral device, which is compatible with the operating system (OS) of the information device.

### DISCLOSURE OF INVENTION

(1) to (12) below are summaries for a device driver providing method, an information device, and a peripheral device according to the present invention that resolves the above problem.

(1) A device driver providing method of providing an information device including an external interface with a device driver for a peripheral device to be connected through the external interface, includes:

a first step in which, when the peripheral device is connected to the information device through the external interface, the information device transmits information related to an operating system in the information device to the peripheral device;

a second step in which the peripheral device determines whether a device driver, which is compatible with the received information related to the operating system, is stored in the peripheral device; and

a third step in which, when it is determined that the device driver is stored, the peripheral device transmits the device driver to the information device.

(2) A device driver providing method of providing an information device including an external interface and storing a device driver for a peripheral device with a device driver for a peripheral device to be connected through the external interface, includes:

a first step in which, when the peripheral device is connected to the information device through the external interface, the information device transmits information related to an operating system in the information device and information related to a version of the device driver stored in advance, to the peripheral device;

a second step in which the peripheral device determines whether a device driver, which is compatible with the received information related to the operating system and which is newer than the received version of the device driver, is stored in the peripheral device; and

a third step in which, when it is determined that the device driver, which is compatible with the received information related to the operating system and which is newer than the received version of the device driver, is stored, the peripheral device transmits the device driver to the information device.

(3) A device driver providing method of providing an information device including an external interface with a device driver for a peripheral device to be connected through the external interface, includes:

a first step in which, when the peripheral device is connected to the information device through the external interface, the peripheral device transmits information related to an operating system compatible with a device driver stored in the peripheral device to the information device;

a second step in which the information device determines whether the received information related to the operating system is identical with an operating system in the information device;

a third step in which, when it is determined that the received information related to the operating system is identical with the operating system in the information device, the information device requests the peripheral device to transmit a compatible device driver; and

a fourth step in which, the peripheral device transmits the compatible device driver to the information device in response to the request for transmission.

(4) A device driver providing method of providing an information device including an external interface and storing a device driver for a peripheral device in advance with a device driver for a peripheral device to be connected through the external interface, includes:

a first step in which, when the peripheral device is connected to the information device through the external interface, the peripheral device transmits information related to an operating system compatible with a device driver stored in the peripheral device and information related to a version of the device driver, to the

a second step in which the information device determines whether the information device corresponds to the received information related to the operating system and a version of the device driver stored in advance is newer than the received version of the device driver;

a third step in which, when it is determined that the information device corresponds to the received information related to the operating system and the version of the device driver stored in advance is newer than the received version of the device driver, the information device transmits a request for transmission of a device driver to the peripheral device; and

a fourth step in which, the peripheral device transmits a compatible device driver to the information device in response to the request for transmission.

(5) An information device which is connectable to a peripheral device through an external interface, includes:

a transmission section which transmits information related to an operating system in the information device to the peripheral device when the peripheral device is connected to the information device; and

a reception section which receives a device driver compatible with the information related to the operating system when the peripheral device transmits the device driver.

(6) An information device which is connectable to a peripheral device through an external interface and which stores a device driver for a peripheral device in advance, includes:

a transmission section which transmits information related to an operating system in the information device and information related to a version of the device driver to the peripheral device when the peripheral device is connected to the information device; and

a reception section which receives the device driver based on the information related to the operating system and the information related to the version of the device driver.

(7) An information device which is connectable to a peripheral device through an external interface, includes:

a reception section which receives, from the peripheral device, information related to an operating system compatible with a device driver stored in the peripheral device when the information device is connected to the peripheral device;

a determination section which determines whether the information, which is received by the reception section and is related to the operating system, is identical with an operating system in the information device; and

a transmission section which requests the peripheral device to transmit a device driver when the determination section determines that the received information is identical with the operating system in the information device,

wherein the reception section further receives a device driver transmitted from the peripheral device in response to the request for transmission.

(8) An information device which is connectable to a peripheral device through an external interface and which stores a device driver for a peripheral device in advance, includes:

a reception section, which receives, from the peripheral device, information related to an operating system compatible with a device driver stored in the peripheral device and information related to a version of a device driver stored in the peripheral device when the information device is connected to the peripheral device;

a determination section which determines whether the information, which is received by the reception section and is related to the operating system, is identical with an operating system in the information device, and whether the received version of the device driver is newer than the version of the device driver stored in advance; and

a transmission section which requests the peripheral device to transmit a device driver when the determination section determines that the received version is newer,

wherein the reception section further receives a device driver transmitted from the peripheral device in response to the request for transmission.

(9) A peripheral device which includes a storage section storing a device driver and which is connectable to an information device through an external interface, includes:

a reception section which receives information related to an operating system in the information device and transmitted from the information device when the peripheral device is connected to the information device;

a determination section which determines whether a device driver compatible with the information received by the reception section is stored in the storage section; and

a transmission section which transmits the device driver compatible with the information to the information device when the determination section determines that the compatible device driver is stored.

(10) A peripheral device which includes a storage section storing a device driver and which is connectable to an information device through an external interface, includes:

a reception section which receives information related to an operating system in the information device and information related to a version of a device driver stored in the information device which are transmitted from the information device, when the peripheral device is connected to the information device;

a determination section which determines whether a device driver, which is compatible with the information related to the operating system received by the reception section and which is newer than the received version of the device driver, is stored in the storage section; and

a transmission section which transmits the device driver of the new version to the information device when the determination section determines that the compatible device driver of the new version is stored.

(11) A peripheral device which includes a storage section storing a device driver and which is connectable to an information device through an external interface, includes:

a transmission section which transmits information related to an operating system compatible with a device driver stored in the storage section to the information device when the peripheral device is connected to the information device; and

a reception section which receives a request for transmission of a device driver transmitted from the information device,

wherein the transmission section transmits, to the information device, a device driver in accordance with the request for transmission received by the reception section.

(12) A peripheral device which includes a storage section storing a device driver and which is connectable to an information device through an external interface, includes:

a transmission section which transmits information related to an operating system compatible with a device driver stored in the storage section and information related to a version of the device driver to the information device when the peripheral device is connected to the information device; and

a reception section which receives a request for transmission of a device driver transmitted from the information device,

wherein the transmission section transmits, to the information device, a device driver in accordance with the request for transmission received by the reception section.

According to the present invention of (1) to (12) described above, it is possible to install, in the information device, a correct device driver for the peripheral device, which is compatible with the operating system (OS) of the information device.

### BRIEF DESCRIPTION OF DRAWINGS

FIG. 1 is a block diagram showing an information device and a peripheral device according to the present invention;

FIG. 2 is a diagram showing a table stored by the peripheral device according to the present invention;

FIG. 3 is a flowchart showing a device driver providing method according to a first embodiment of the present invention;

FIG. 4 is a diagram showing an example error notification issued by the information device according to the present invention;

FIG. 5 is a flowchart showing a device driver providing method according to a second embodiment of the present invention;

FIG. 6 is a flowchart showing a device driver providing method according to a third embodiment of the present invention; and

FIG. 7 is a flowchart showing a device driver providing method according to a fourth embodiment of the present invention.

In the drawings, reference numeral 100 denotes a personal computer; 101, a USB interface; 102, a storage unit; 103, a controller; 104, an OS (operating system); 105, a driver; 106, a display unit; 200, a mobile phone, 201, a USB interface; 202, a storage unit; 203, a controller; and 204, a driver.

### BEST EMBODIMENTS FOR CARRYING OUT THE INVENTION

The embodiments of the present invention will now be described while referring to drawings.

### First Embodiment

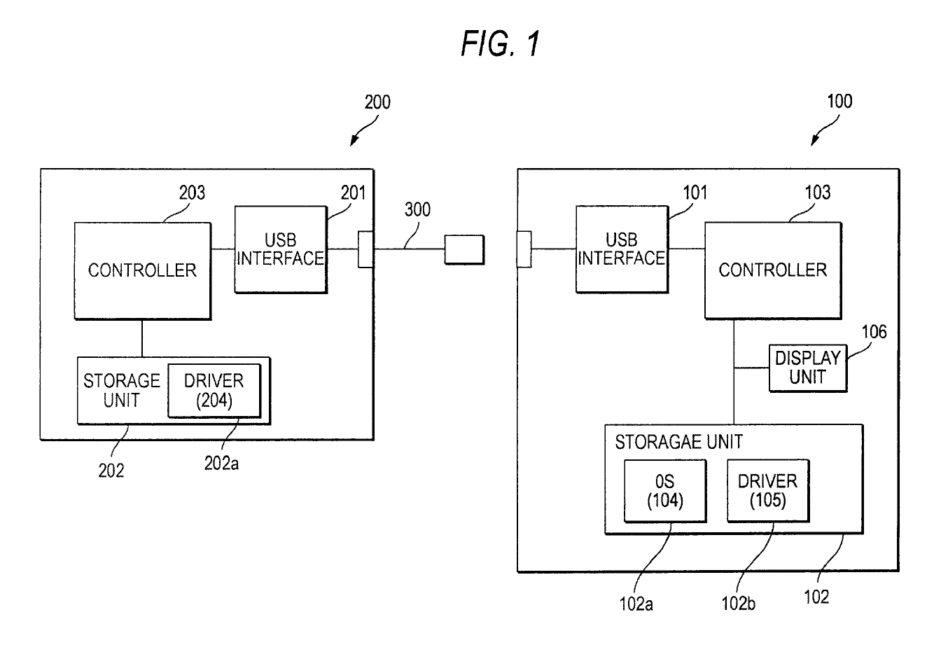

In an example in FIG. 1, a personal computer 100 equipped with a USB interface 101, which is used as an information device according to the present invention, and a mobile phone 200 equipped with a USB interface 201, which is used as a peripheral device, are connected together when in use.

The personal computer 100 includes the USB interface 101, a storage unit 102, such as a memory, a display unit 106, such as a monitor, and a controller 103.

The USB interface 101 is a serial communication interface that conforms to the USB (Universal Serial Bus) Standards, according to which the fast transfer of data is enabled. For example, for a USB interface that conforms to USB 1.1 (USB specifications Rev. 1.1 1998. 9. 2.3) standards, data communication of a maximum 12 mega bits per second is enabled in a full-speed signaling mode.

The storage unit 102 is a memory area used to store not only the setup entries of the personal computer 100 and data related to the initial operation, but also various data saved by a user.

The storage unit 102 includes an OS storage area 102a, wherein an operating system (hereinafter abbreviated as an OS) 104, which is the basic software for the personal computer 100, is stored, and a driver storage area 102b, wherein a device driver (hereinafter abbreviated as a driver) for a peripheral device is to be stored.

A driver stored in the driver storage area 102b is to be installed in the information device 100 through a predetermined operation performed by the user, or through an installation process that will be described later.

The controller 103 controls the USB interface 101, the storage unit 102 and the display unit 106.

The mobile phone 200 includes the USB interface 201, a storage unit 202 and a controller 203.

The USB interface 201, as well as the USB interface provided for the personal computer 100, is a serial communication interface that conforms to the USB standards.

The storage unit 202 is a memory area used not only to store setup entries for the mobile phone 200 and data related to the initial operation, but also various data saved by a user. The storage unit 202 includes a driver storage area 202a wherein a driver 204 is stored, so that an external device can identify the mobile phone 200.

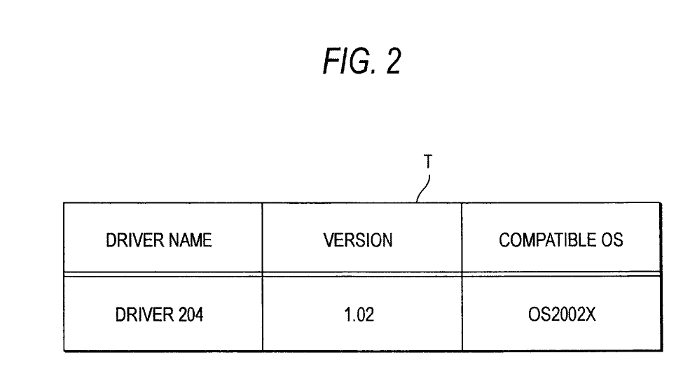

In the driver storage unit 202a, information identifying the version of the driver 204 and information identifying an OS compatible with the driver 204 are stored in correlation with the driver 204, and this information is arranged, for example, in the form of a table T shown in FIG. 2. According to table T, the version of the driver 204 is 1.02 and is compatible with OS “OS2002X”.

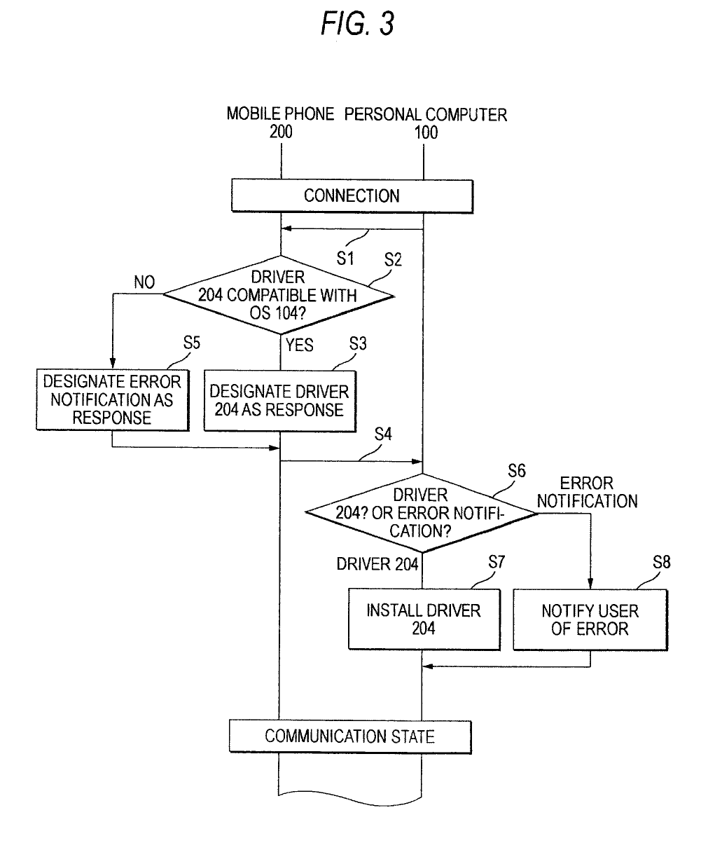

While referring to FIG. 3, an explanation will be given for the processing performed in this embodiment to provide the driver 204 of the mobile phone 200 for the personal computer 100.

First, in order to install the driver of a peripheral device in an information device (set the peripheral device in a standby state), the personal computer 100 and the mobile phone 200 are connected by employing a USB cable 300. Then, the personal computer 100 transmits information identifying its own OS 104 to the mobile phone 200 (S1).

Upon receiving the information related to the OS 104, the mobile phone 200 employs the information and the table T to determine whether the driver 204 is compatible with the OS 104, i.e., whether the OS 104 is identical with “OS2002X” (S2).

When it is determined at S2 that the driver 204 is compatible with the OS 104, the driver 204 is designated to serve as a response to the personal computer 100 (S3), and is transmitted to the personal computer 100 (S4).

On the other hand, when it is determined at S2 that the driver 204 is not compatible with the OS 104, an error notification is designated to serve as a response to the personal computer 100 (S5), and is transmitted to the personal computer 100 (S4).

When the contents of the response received from the mobile phone 200 are the driver 204, the personal computer 100 stores the driver 204 in the driver storage area 102b, and installs the driver 204 internally (S6, S7).

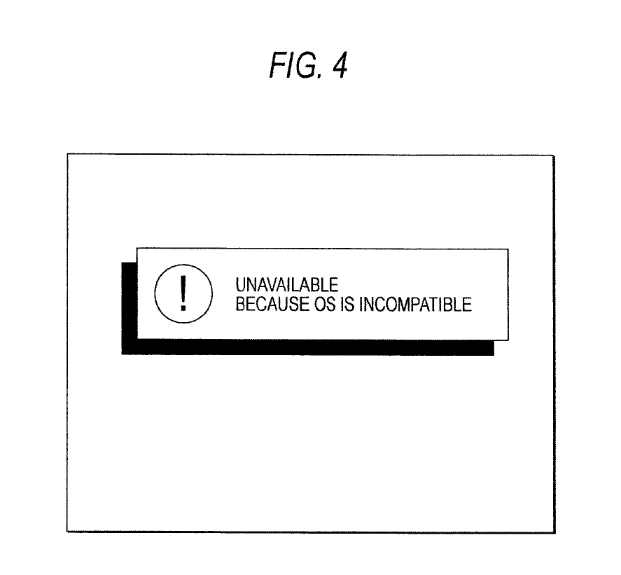

When the contents of the response are an error notification, the personal computer 100 displays, for example, a message shown in FIG. 4 on the display unit 106, so to notify a user that use of the mobile phone 200 is disabled (the driver can not be installed) (S6, S8).

As described above, first, the personal computer 100 transmits, to the mobile phone 200, information identifying the OS 104 in the personal computer 100, and only when the driver 204 stored in the mobile phone 200 is compatible with the OS 104 is the driver 204 transmitted to the personal computer 100. Therefore, the risks can be eliminated that the user will erroneously install an inappropriate driver that is not compatible with the OS 104 and that an erroneous operation will occur due to the mismatching of the driver and the OS. As a result, the installation of the driver can be performed safely.

Furthermore, since the user need not manually install a driver through use of a recording medium, such as an FDD or a CD-ROM, that is packaged with the mobile phone 200, the complexity of the operation, for the user, can be reduced.

### Second Embodiment

A second embodiment of the present invention is a modification of the first embodiment. A driver 105 for a mobile phone 200 is present in advance in a personal computer 100 and is stored in the driver storage area 102b.

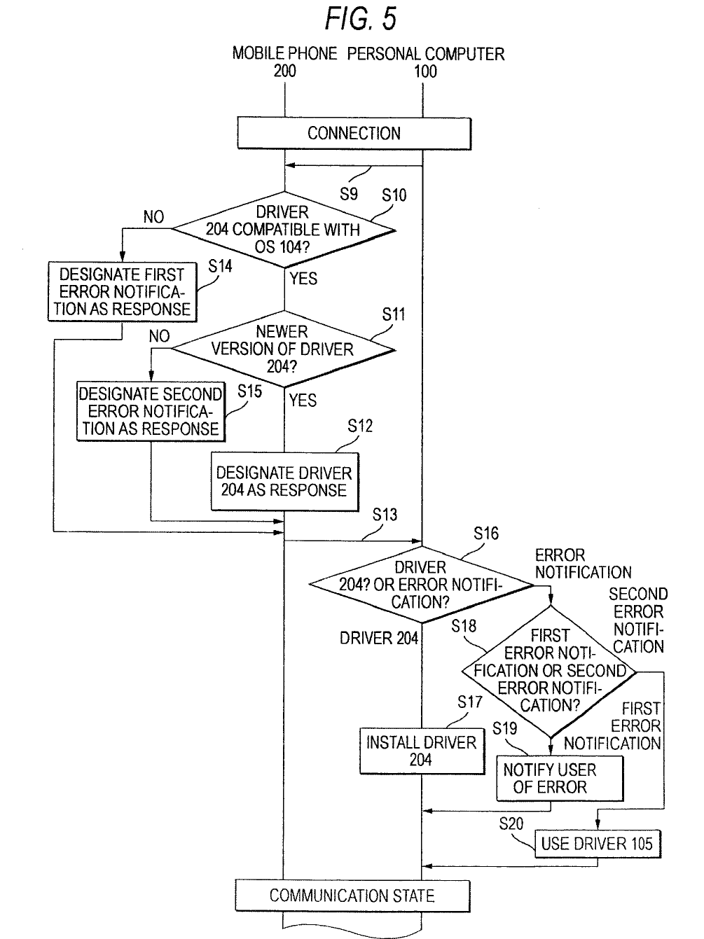

While referring to FIG. 5, an explanation will now be given for the processing performed in this embodiment to provide a driver 204 for the mobile phone 200 to the personal computer 100.

First, in order to install the driver of a peripheral device for an information device (set the peripheral device in a standby state), the personal computer 100 and the mobile phone 200 are connected by employing a USB cable 300. Then, the personal computer 100 transmits to the mobile phone 200 information identifying an OS 104 for the personal computer 104, and information identifying the version of the driver 105 that is stored in the driver storage area 102b (S9).

Upon receiving the information identifying the OS 104 and the information identifying the version of the driver 105, first, the mobile phone 200 employs the information and a table T to determine whether the driver 204 is compatible with the OS 104, i.e., whether the OS 104 is identical with “OS2002X” (S10). When it is determined at S10 that the driver 204 is compatible with the OS 104, then, the mobile phone 200 determines whether the version of the driver 204 is newer than the version of the driver 105 (S11).

When it is determined at S11 that the version of the driver 204 is newer, the driver 204 is designated as a response for the personal computer 100 (S12), and is transmitted to the personal computer 100 (S13).

On the other hand, when it is determined at S10 that the driver 204 is not compatible with the OS 104, a first error notification is designated as the response for the personal computer 100 (S14), and is transmitted to the personal computer 100 (S13).

Or, when it is determined at S10 that the driver 204 is compatible with the OS 104, but it is determined at S11 that the version of the driver 105 is newer, a second error notification is designated as the response for the personal computer 100 (S15), and is transmitted to the personal computer 100 (S13).

When the contents of the response received from the mobile phone 200 are the driver 204, the personal computer 100 stores the driver 204 in the driver storage area 102b and installs the driver 204 internally (S16, S17).

On the other hand, when the content of the response is the first error notification, the personal computer 100 displays, for example, a message shown in FIG. 4 on the display unit 106 to notify the user that use of the mobile phone 200 is disabled (the driver can not be installed) (S18, S19).

When the content of the response is the second error notification, the personal computer 100 installs the driver 105 stored in advance in the driver storage area 102b, and employs the driver 105 (S18, S20).

As described above, first, the personal computer 100 transmits to the mobile phone 200 the OS 104 of the personal computer 100 and the version information for the driver 105 that is stored internally, and only when the driver 204 stored in the mobile phone 200 is compatible with the OS 104, or when the driver 204 is a version newer than the driver 105, is the driver 204 transmitted to the personal computer 100. Therefore, the driver of the old version need not be transmitted by the mobile phone 200, and a later version driver, either a driver stored in the personal computer 100 or a driver stored in the mobile phone 200, can be employed.

### Third Embodiment

According to a third embodiment of the present invention, first, a mobile phone 200 transmits, to a personal computer 100, information concerning a driver 204 stored in the mobile phone 200.

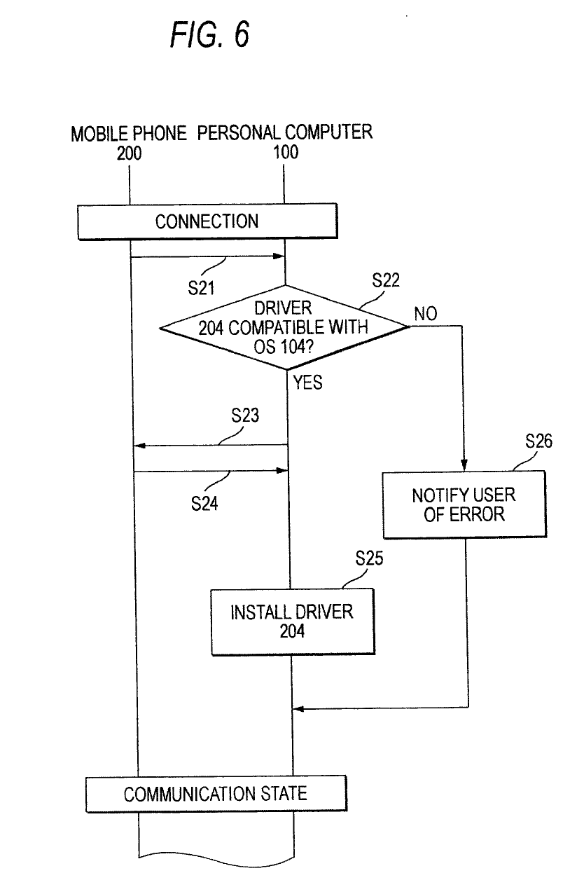

While referring to FIG. 6, an explanation will now be given for the processing performed in this embodiment to provide the driver 204 of the mobile phone 200 to the personal computer 100.

First, in order to install a driver for a peripheral device in an information device (to set the peripheral device in a standby state), the personal computer 100 and the mobile phone 200 are connected by employing a USB cable 300. Then, the mobile phone 200 transmits to the personal computer 100 a table T shown in FIG. 2, which is information identifying an OS that is compatible with the driver 204 stored internally (S21).

Upon receiving the table T, the personal computer 100 examines the table T, and determines whether the driver 204 is compatible with the OS 104 of the personal computer 100 (S22). When it is determined at S22 that the driver 204 is compatible with the OS 104, the personal computer 100 transmits a driver transmission request to the mobile phone 200 (S23).

Upon receiving the driver transmission request, the mobile phone 200 transmits the driver 204 to the personal computer 100 (S24). The personal computer 100 then stores the received driver 204 in the driver storage area 102b and installs the driver 204 internally (S25). On the other hand, if it is determined at S22 that the driver 204 is not compatible with the OS 104, the personal computer 100 displays a message in FIG. 4, for example, on the display unit 106 to notify a user that the of the mobile phone 200 is disabled (S26).

As described above, first, the mobile phone 200 transmits information indicating that the OS that is compatible with the driver 204 is stored internally, and only when it is determined that the driver 204 is compatible with the OS 104 of the personal computer 100 is the driver 204 provided for the personal computer 100. Therefore, the risks can be eliminated that a user will erroneously install an inappropriate driver that is not compatible with the OS 104 and that an erroneous operation will occur due to the mismatching of the driver and the OS. As a result, the installation of the driver can be performed safely.

Furthermore, since the user need not manually install a driver through use of a recording medium, such as an FDD or a CD-ROM, that is packaged with the mobile phone 200, the complexity of the operation, for the user for, can be reduced.

### Fourth Embodiment

A fourth embodiment of the present invention is a modification of the third embodiment. A driver 105 for a mobile phone 200 is present in advance in a personal computer 100 and is stored in the driver storage area 102b.

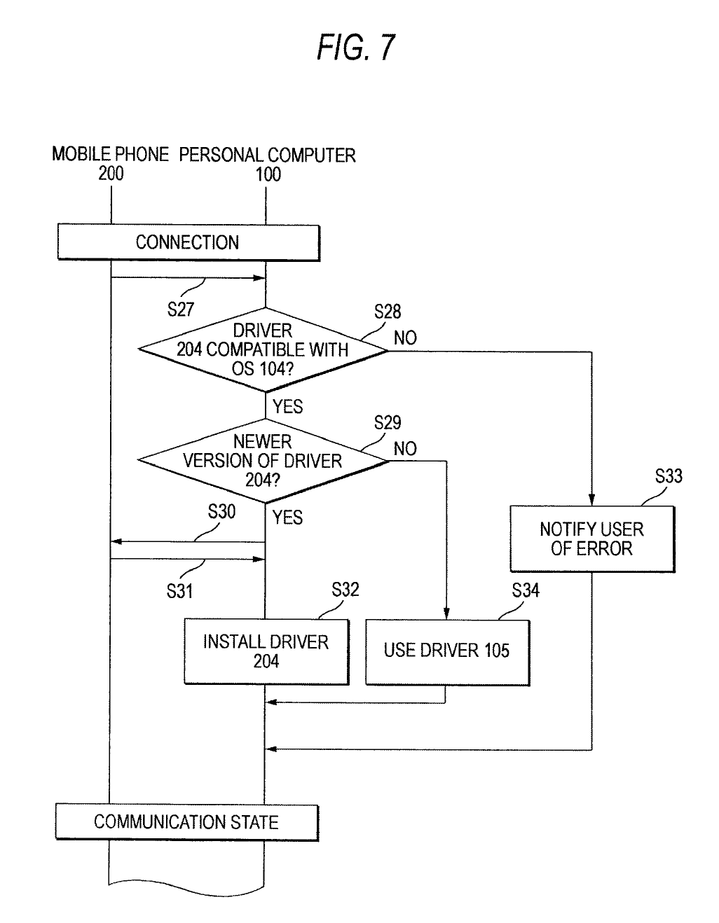

While referring to FIG. 7, an explanation will now be given for the processing performed in this embodiment to provide a driver 204 for the mobile phone 200 to the personal computer 100.

First, in order to install a driver for a peripheral device in an information device (set the peripheral device in a standby state), the personal computer 100 and the mobile phone 200 are connected by employing a USB cable 300. Then, the mobile phone 200 transmits to the personal computer 100 a table T, shown in FIG. 2, that is information identifying the OS that is compatible with the driver 204 internally stored and information identifying the version of the driver 204 (S27).

Upon receiving the table T, first, the personal computer 100 examines the table T and determines whether the driver 204 is compatible with the OS 104 of the personal computer 100 (S28). When it is determined at S28 that the driver 204 is compatible with the OS 104, then, the personal computer 100 determines whether the version of the driver 204 is newer than the version of the driver 105 stored internally (the driver storage unit 102b) (S29).

When it is determined at S29 that the version of the driver 204 is newer, the personal computer 100 transmits a driver transmission request to the mobile phone 200 (S30).

Upon receiving the driver transmission request, the mobile phone 200 transmits the driver 204 to the personal computer 100 (S31).

The personal computer 100 stores the received driver 204 in the driver storage area 102b, and installs the driver 204 internally (S32).

On the other hand, when it is determined at S28 that the driver 204 is not compatible with the OS 104, the personal computer 100 displays a message in FIG. 4, for example, on the display unit 106 to notify a user that use of the mobile phone 200 is disabled (S33).

Or, when it is determined at S28 that the driver 204 is compatible with the OS 104, but it is determined at S29 that the driver 105 is newer than the driver 204, the personal computer 100 installs the driver 105 stored in advance in the driver storage area 102b and employs the driver 105 (S34).

As described above, first, the mobile phone 200 transmits information identifying the OS compatible with the driver 204 internally stored and information identifying the version of the driver 204, and only when it is determined that the driver 204 is compatible with the OS 104 of the personal computer 100, or when it is determined that the driver 204 is a newer version than the driver 105 stored in advance in the personal computer 100, is the driver 204 provided for the personal computer 100. Therefore, the driver of the old version need not be transmitted by the mobile phone 200, and a later version driver, either a driver stored in the personal computer 100 or a driver stored in the mobile phone 200, can be employed.

The first to the fourth embodiments have been employed while referring to FIGS. 1 to 7. However, embodiments of the present invention are not limited to these, and it goes without saying that the present invention can be variously modified within the scope of the technical idea described in the claims of the invention.

Specifically, the relationship between the personal computer and the mobile phone in this invention is a so-called relationship between a host and a device. However, the mobile phone may be employed as a host (an information device) while the personal computer may be employed as a device (a peripheral device), and information identifying the OS in the mobile phone may be exchanged with the personal computer.

Further, the information device and the peripheral device in this invention are not respectively limited to a personal computer and a mobile phone. An information device may be a desktop computer, such as a workstation, or a portable communication apparatus, such as a PDA (Personal Digital Assistant) or a mobile phone, and a peripheral device may be an arbitrary type of data processing apparatus, such as a printer, a scanner or a digital camera.

Furthermore, in the first to the fourth embodiments, when the information device receives the driver from the peripheral device, the driver is stored in the storage area and is automatically installed. However, the operation is not limited to this, and the information device may simply store the received driver in the storage area and the actual installation operation may be manually performed by a user.

In addition, in the examples in the first and the fourth embodiments, only one driver is stored in the peripheral device. However, the number of drivers is not limited to one. The peripheral device may store a driver compatible with a plurality of OSes, or drivers for a plurality of versions. In this case, only whether one of a plurality of drivers is compatible with the OS of the information device need be determined.

### INDUSTRIAL APPLICABILITY

According to the inventions in (1) to (12), since the device driver of the peripheral device that is compatible with the operating system (OS) of the information device can be appropriately installed in the information device, the industrial applicability is extremely great.

It should be noted that the present invention is not limited to the above described embodiments.

1. A device driver providing method of providing an information device including an external interface with a device driver for a peripheral device to be connected through the external interface, comprising:
a first step in which, when the peripheral device is connected to the information device through the external interface, the information device transmits information related to an operating system in the information device to the peripheral device;
a second step in which the peripheral device determines whether a device driver, which is compatible with the received information related to the operating system, is stored in the peripheral device; and
a third step in which, when it is determined that the device driver is stored, the peripheral device transmits the device driver to the information device.

2. A device driver providing method of providing an information device including an external interface and storing a device driver for a peripheral device with a device driver for a peripheral device to be connected through the external interface, comprising:
a first step in which, when the peripheral device is connected to the information device through the external interface, the information device transmits information related to an operating system in the information device and information related to a version of the device driver stored in advance, to the peripheral device;
a second step in which the peripheral device determines whether a device driver, which is compatible with the received information related to the operating system and which is newer than the received version of the device driver, is stored in the peripheral device; and
a third step in which, when it is determined that the device driver, which is compatible with the received information related to the operating system and which is newer than the received version of the device driver, is stored, the peripheral device transmits the device driver to the information device.

3. A device driver providing method of providing an information device including an external interface with a device driver for a peripheral device to be connected through the external interface, comprising:
a first step in which, when the peripheral device is connected to the information device through the external interface, the peripheral device transmits information related to an operating system compatible with a device driver stored in the peripheral device to the information device;
a second step in which the information device determines whether the received information related to the operating system is identical with an operating system in the information device;
a third step in which, when it is determined that the received information related to the operating system is identical with the operating system in the information device, the information device requests the peripheral device to transmit a compatible device driver; and
a fourth step in which, the peripheral device transmits the compatible device driver to the information device in response to the request for transmission.

4. A device driver providing method of providing an information device including an external interface and storing a device driver for a peripheral device in advance with a device driver for a peripheral device to be connected through the external interface, comprising:
a first step in which, when the peripheral device is connected to the information device through the external interface, the peripheral device transmits information related to an operating system compatible with a device driver stored in the peripheral device and information related to a version of the device driver, to the information device;
a second step in which the information device determines whether the information device corresponds to the received information related to the operating system and a version of the device driver stored in advance is newer than the received version of the device driver;
a third step in which, when it is determined that the information device corresponds to the received information related to the operating system and the version of the device driver stored in advance is newer than the received version of the device driver, the information device transmits a request for transmission of a device driver to the peripheral device; and
a fourth step in which, the peripheral device transmits a compatible device driver to the information device in response to the request for transmission.

5. An information device which is connectable to a peripheral device through an external interface, comprising:
a transmission section which transmits information related to an operating system in the information device to the peripheral device when the peripheral device is connected to the information device; and
a reception section which receives a device driver compatible with the information related to the operating system when the peripheral device transmits the device driver.

6. An information device which is connectable to a peripheral device through an external interface and which stores a device driver for a peripheral device in advance, comprising:
a transmission section which transmits information related to an operating system in the information device and information related to a version of the device driver to the peripheral device when the peripheral device is connected to the information device; and
a reception section which receives the device driver the information related to the operating system and the information related to the version of the device driver.

7. An information device which is connectable to a peripheral device through an external interface, comprising:
a reception section which receives, from the peripheral device, information related to an operating system compatible with a device driver stored in the peripheral device when the information device is connected to the peripheral device;
a determination section which determines whether the information, which is received by the reception section and is related to the operating system, is identical with an operating system in the information device; and
a transmission section which requests the peripheral device to transmit a device driver when the determination section determines that the received information is identical with the operating system in the information device,
wherein the reception section further receives a device driver transmitted from the peripheral device in response to the request for transmission.

8. An information device which is connectable to a peripheral device through an external interface and which stores a device driver for a peripheral device in advance, comprising:
a reception section, which receives, from the peripheral device, information related to an operating system compatible with a device driver stored in the peripheral device and information related to a version of a device driver stored in the peripheral device when the information device is connected to the peripheral device;
a determination section which determines whether the information, which is received by the reception section and is related to the operating system, is identical with an operating system in the information device, and whether the received version of the device driver is newer than the version of the device driver stored in advance; and
a transmission section which requests the peripheral device to transmit a device driver when the determination section determines that the received version is newer,
wherein the reception section further receives a device driver transmitted from the peripheral device in response to the request for transmission.

9. A peripheral device which includes a storage section storing a device driver and which is connectable to an information device through an external interface, comprising:
a reception section which receives information related to an operating system in the information device and transmitted from the information device when the peripheral device is connected to the information device;
a determination section which determines whether a device driver compatible with the information received by the reception section is stored in the storage section; and
a transmission section which transmits the device driver compatible with the information to the information device when the determination section determines that the compatible device driver is stored.

10. A peripheral device which includes a storage section storing a device driver and which is connectable to an information device through an external interface, comprising:
a reception section which receives information related to an operating system in the information device and information related to a version of a device driver stored in the information device which are transmitted from the information device, when the peripheral device is connected to the information device;
a determination section which determines whether a device driver, which is compatible with the information related to the operating system received by the reception section and which is newer than the received version of the device driver, is stored in the storage section; and
a transmission section which transmits the device driver of the new version to the information device when the determination section determines that the compatible device driver of the new version is stored.

11. A peripheral device which includes a storage section storing a device driver and which is connectable to an information device through an external interface, comprising:
a transmission section which transmits information related to an operating system compatible with a device driver stored in the storage section to the information device when the peripheral device is connected to the information device; and
a reception section which receives a request for transmission of a device driver transmitted from the information device,
wherein the transmission section transmits, to the information device, a device driver in accordance with the request for transmission received by the reception section.

12. A peripheral device which includes a storage section storing a device driver and which is connectable to an information device through an external interface, comprising:
a transmission section which transmits information related to an operating system compatible with a device driver stored in the storage section and information related to a version of the device driver to the information device when the peripheral device is connected to the information device; and
a reception section which receives a request for transmission of a device driver transmitted from the information device,
wherein the transmission section transmits, to the information device, a device driver in accordance with the request for transmission received by the reception section.
